(19) United States
(12) Patent Application Publication
(10) Pub. No.: US 2024/0378689 A1
(43) Pub. Date: Nov. 14, 2024

(54) REAL TIME DYNAMIC USER ENGAGEMENT ASSISTANCE

(71) Applicant: International Business Machines Corporation, Armonk, NY (US)

(72) Inventors: Fang Lu, Billerica, MA (US); JOHN RUSSELL GERBERICH, Palatine, IL (US); Jeremy R. Fox, Georgetown, TX (US); Jana H. Jenkins, Raleigh, NC (US); Charles E. Beller, Baltimore, MD (US)

(21) Appl. No.: 18/314,886

(22) Filed: May 10, 2023

(51) Int. Cl. G06Q 50/20

(52) U.S. Cl. CPC G06Q 50/2057

(57) ABSTRACT

A processor may receive user profile data associated with one or more users. The processor may generate a user training corpus for conversing with the one or more users. The processor may generate, based on the user training corpus and user profile data, an optimal template script for conversing with the one or more users.

### BACKGROUND

The present disclosure relates generally to the field of the user engagement, and more specifically to real time dynamic user engagement assistance.

As global economies evolve, working with users from different backgrounds is necessary. Different corporations are increasingly encouraging their staff to adjust and apply their skills with the consideration that will enhance business engagement success and sales opportunities internationally. This is also important when people receive training on a new product, on services with new technology, and with terminologies that are created from different locations.

### SUMMARY

Embodiments of the present disclosure include a method, computer program product, and system for dynamic conversation engagement. A processor may receive user profile data associated with one or more users. The processor may generate a user training corpus for conversing with the one or more users. The processor may generate, based on the user training corpus and user profile data, an optimal template script for conversing with the one or more users.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a block diagram illustrating an embodiment of a computer system and the components thereof, upon which embodiments described herein may be implemented in accordance with the present disclosure.

FIG. 2 depicts a block diagram illustrating an extension of the computing system environment of FIG. 1, wherein the computer systems are configured to operate in a network environment (including a cloud environment), and perform methods described herein in accordance with the present disclosure.

FIG. 3 illustrates a block diagram of an example dynamic conversation engagement system, in accordance with aspects of the present disclosure.

FIG. 4 illustrates a flowchart of an example method for a dynamic conversation engagement, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of the user engagement, and more specifically to real time dynamic user engagement assistance. While the present disclosure is not necessarily limited to such applications, various aspects of the disclosure may be appreciated through a discussion of various examples using this context.

As will be discussed more fully throughout this disclosure, as global economies evolve, working with users from different backgrounds is necessary. Different corporations are increasingly encouraging their staff to adjust and apply their skills with the consideration that will enhance business engagement success and sales opportunities internationally. This is also important when people receive training on a new product, on services with new technology, and with terminologies that are created from different locations. Accordingly, it is essential to develop a solution, such as a system/assistant, that can be integrated with product training and communications training.

Such a solution is discussed throughout this disclosure, and such a solution can greatly improve an end user's training process for working on customer (e.g., other users) facing sales, interactions, and/or communication techniques through AI/machine learning/chatbot-based solutions. The disclosed solution can use metadata information associated with a conversation (between a user, a chatbot, etc. and another user) and the outcome of the overall conversation process, and recommend improvements from different commerce-based engagement aspects.

In some embodiments, the solution, as a system, analyzes different data and metadata extracted from the communication/conversation/or communications from the conversation associated with the speakers as well as the type of questions or answers provided during the conversation to determine which areas within the communication can be improved to help with interactions between the user and the assistant.

In some embodiments, the system further analyzes the outcome of the process (e.g., the conversation) to determine which areas can be improved. In some embodiments, the system assigns various visual methods to identify each speaker (e.g., color coding names of speakers on a conference call, etc.) and uses these differentiated means to indicate varying types of questions and the corresponding answers communicated during the conversation (e.g., A is an engineer whose name is colored green, which means A uses the word “database,” whereas B is a business person whose name is colored blue, which means B uses the word “repository,” etc.). In some embodiments, suggested responses during the conversation may be infused into a template to be used by the assistant (e.g., chatbot of the system, a user, etc.) in real-time. The suggested responses may be provided by an expert in the area related to the conversation/communications, or may be generated by an AI of the system after analyzing other conversations.

Before turning to the FIGS. it is noted that various aspects of the present disclosure are described by narrative text, flowcharts, block diagrams of computer systems and/or block diagrams of the machine logic included in computer program product (CPP) embodiments. With respect to any flowcharts (depending upon the technology involved) the operations can be performed in a different order than what is shown in the flowchart. For example, two operations shown in successive flowchart blocks may be performed in reverse order, as a single integrated step, concurrently, or in a manner at least partially overlapping in time. A computer program product embodiment (“CPP embodiment”) is a term used in the present disclosure that may describe any set of one or more storage media (or “mediums”) collectively included in a set of one or more storage devices. The storage media may collectively include machine readable code corresponding to instructions and/or data for performing computer operations. A “storage device” may refer to any tangible hardware or device that can retain and store instructions for use by a computer processor. Without limitation, the computer readable storage medium may include an electronic storage medium, a magnetic storage medium, an optical storage medium, an electromagnetic storage medium, a semiconductor storage medium, a mechanical storage medium, and/or any combination thereof. Some known types of storage devices that include mediums referenced herein may include a diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination thereof. A computer-readable storage medium should not be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As understood by those skilled in the art, data is typically moved at some occasional points in time during normal operations of a storage device, such as during access, de-fragmentation or garbage collection, but this does not render the storage device as transitory because the data is not transitory while it is stored.

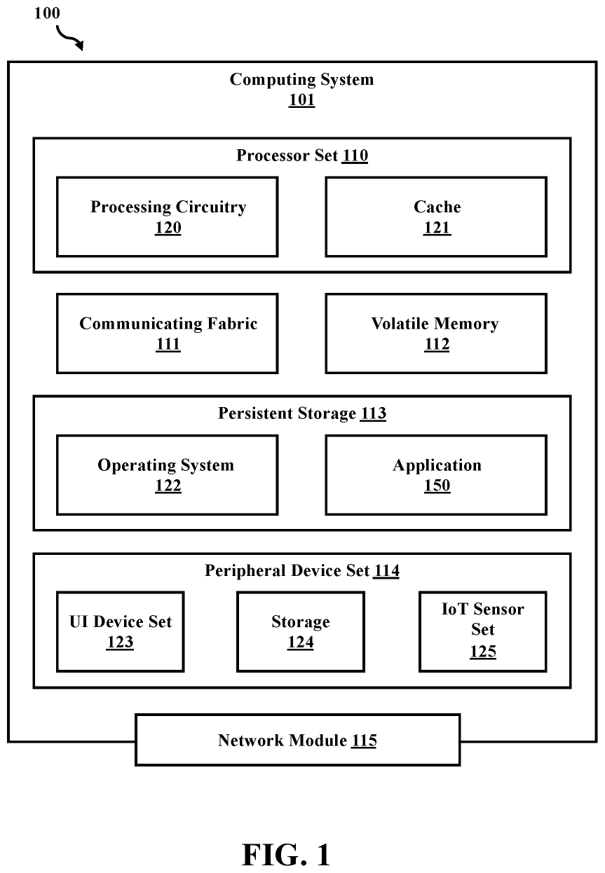

Referring now to FIG. 1, illustrated is a block diagram describing an embodiment of a computing system 101 within in a computing environment, which may be a simplified example of a computing device (i.e., a physical bare metal system and/or a virtual system) capable of performing the computing operations described herein. Computing system 101 may be representative of the one or more computing systems or devices implemented in accordance with the embodiments of the present disclosure and further described below in detail. It should be appreciated that FIG. 1 provides only an illustration of one implementation of a computing system 101 and does not imply any limitations regarding the environments in which different embodiments may be implemented. In general, the components illustrated in FIG. 1 may be representative of an electronic device, either physical or virtualized, capable of executing machine-readable program instructions.

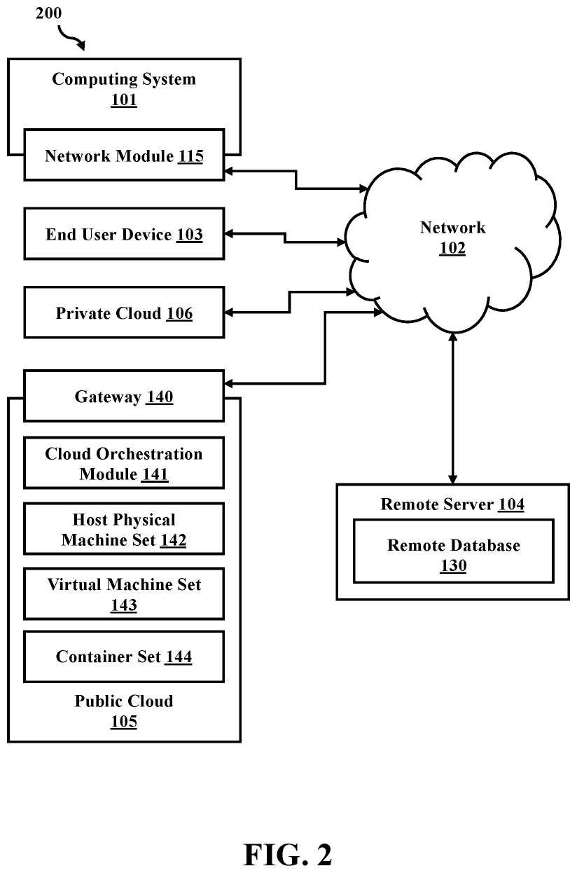

Embodiments of computing system 101 may take the form of a desktop computer, laptop computer, tablet computer, smart phone, smart watch or other wearable computer, mainframe computer, server, quantum computer, a non-conventional computer system such as an autonomous vehicle or home appliance, or any other form of computer or mobile device now known or to be developed in the future that is capable of running a program 150, accessing a network 102 or querying a database, such as remote database 130. Performance of a computer-implemented method executed by a computing system 101 may be distributed among multiple computers and/or between multiple locations. Computing system 101 may be located as part of a cloud network, even though it is not shown within a cloud in FIGS. 1-2. Moreover, computing system 101 is not required to be in a cloud network except to any extent as may be affirmatively indicated.

Processor set 110 includes one, or more, computer processors of any type now known or to be developed in the future. Processing circuitry 120 may be distributed over multiple packages. For example, multiple, coordinated integrated circuit chips. Processing circuitry 120 may implement multiple processor threads and/or multiple processor cores. Cache 121 may refer to memory that is located on the processor chip package(s) and/or may be used for data or code that can be made available for rapid access by the threads or cores running on processor set 110. Cache 121 memories can be organized into multiple levels depending upon relative proximity to the processing circuitry 120. Alternatively, some, or all of cache 121 of processor set 110 may be located “off chip.” In some computing environments, processor set 110 may be designed for working with qubits and performing quantum computing.

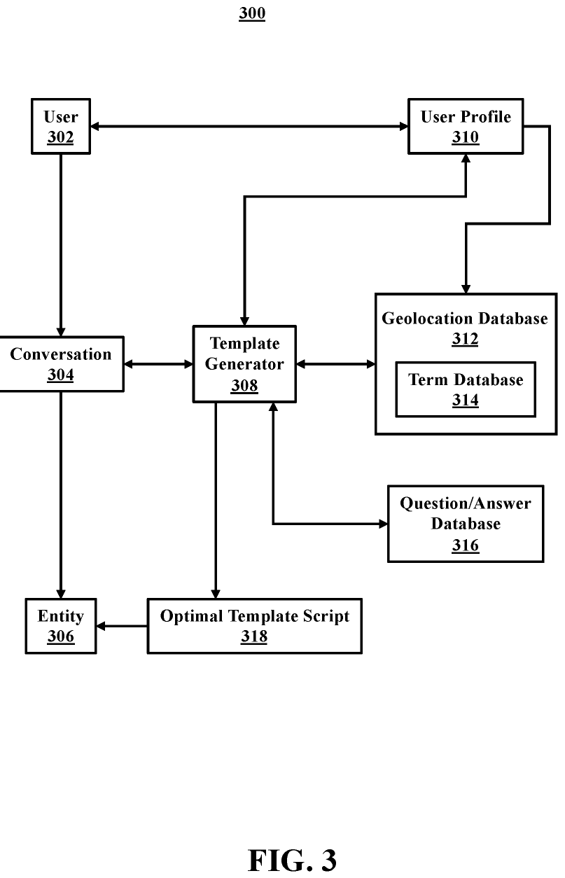

Computer readable program instructions can be loaded onto computing system 101 to cause a series of operational steps to be performed by processor set 110 of computing system 101 and thereby implement a computer-implemented method. Execution of the instructions can instantiate the methods specified in flowcharts and/or narrative descriptions of computer-implemented methods included in this specification (collectively referred to as “the inventive methods”). The computer readable program instructions can be stored in various types of computer readable storage media, such as cache 121 and the other storage media discussed herein. The program instructions, and associated data, can be accessed by processor set 110 to control and direct performance of the inventive methods. In computing environments of FIGS. 1-2, at least some of the instructions for performing the inventive methods may be stored in persistent storage 113, volatile memory 112, and/or cache 121, as application(s) 150 comprising one or more running processes, services, programs and installed components thereof. For example, program instructions, processes, services and installed components thereof may include the components and/or sub-components of the system 300 as shown in FIG. 3.

Communication fabric 111 may refer to signal conduction paths that may allow the various components of computing system 101 to communicate with each other. For example, communications fabric 111 can provide for electronic communication among the processor set 110, volatile memory 112, persistent storage 113, peripheral device set 114 and/or network module 115. Communication fabric 111 can be made of switches and/or electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 may refer to any type of volatile memory now known or to be developed in the future, and may be characterized by random access, but this is not required unless affirmatively indicated. Examples include dynamic type random access memory (RAM) or static type RAM. In computing system 101, the volatile memory 112 is located in a single package and can be internal to computing system 101, but, alternatively or additionally, the volatile memory 112 may be distributed over multiple packages and/or located externally with respect to computing system 101. Application 150, along with any program(s), processes, services, and installed components thereof, described herein, may be stored in volatile memory 112 and/or persistent storage 113 for execution and/or access by one or more of the respective processor sets 110 of the computing system 101.

Persistent storage 113 can be any form of non-volatile storage for computers that may be currently known or developed in the future. The non-volatility of this storage means that the stored data may be maintained regardless of whether power is being supplied to computing system 101 and/or directly to persistent storage 113. Persistent storage 113 may be a read only memory (ROM), however, at least a portion of the persistent storage 113 may allow writing of data, deletion of data and/or re-writing of data. Some forms of persistent storage 113 may include magnetic disks, solid-state storage devices, hard drives, flash-based memory, erasable read-only memories (EPROM) and semi-conductor storage devices. Operating system 122 may take several forms, such as various known proprietary operating systems or open-source Portable Operating System Interface type operating systems that employ a kernel.

Peripheral device set 114 includes one or more peripheral devices connected to computing system 101. For example, via an input/output (I/O interface). Data communication connections between the peripheral devices and the other components of computing system 101 may be implemented using various methods. For example, through connections using Bluetooth, Near-Field Communication (NFC), wired connections or cables (such as universal serial bus (USB) type cables), insertion type connections (for example, secure digital (SD) card), connections made though local area communication networks and/or wide area networks such as the internet. In various embodiments, UI device set 123 may include components such as a display screen, speaker, microphone, wearable devices (such as goggles, headsets and smart watches), keyboard, mouse, printer, touchpad, game controllers, and haptic feedback devices. Storage 124 can include external storage, such as an external hard drive, or insertable storage, such as an SD card. Storage 124 may be persistent and/or volatile. In some embodiments, storage 124 may take the form of a quantum computing storage device for storing data in the form of qubits. In some embodiments, networks of computing systems 101 may utilize clustered computing and components acting as a single pool of seamless resources when accessed through a network by one or more computing systems 101. For example, a storage area network (SAN) that is shared by multiple, geographically distributed computer systems 101 or network-attached storage (NAS) applications. IoT sensor set 125 can be made up of sensors that can be used in Internet-of-Things applications. For example, a sensor may be a temperature sensor, motion sensor, infrared sensor or any other type of known sensor type.

Network module 115 may include a collection of computer software, hardware, and/or firmware that allows computing system 101 to communicate with other computer systems through a network 102, such as a LAN or WAN. Network module 115 may include hardware, such as modems or Wi-Fi signal transceivers, software for packetizing and/or de-packetizing data for communication network transmission, and/or web browser software for communicating data over the network. In some embodiments, network control functions and network forwarding functions of network module 115 are performed on the same physical hardware device. In other embodiments (for example, embodiments that utilize software-defined networking (SDN)), the control functions and the forwarding functions of network module 115 can be performed on physically separate devices, such that the control functions manage several different network hardware devices. Computer readable program instructions for performing the inventive methods can typically be downloaded to computing system 101 from an external computer or external storage device through a network adapter card or network interface included in network module 115.

Continuing, FIG. 2 depicts a computing environment 200 which may be an extension of the computing environment 100 of FIG. 1, operating as part of a network. In addition to computing system 101, computing environment 200 can include a network 102 such as a wide area network (WAN) (or another type of computer network) connecting computing system 101 to an end user device (EUD) 103, remote server 104, public cloud 105, and/or private cloud 106. In this embodiment, computing system 101 includes processor set 110 (including processing circuitry 120 and cache 121), communication fabric 111, volatile memory 112, persistent storage 113 (including operating system 122 and program(s) 150, as identified above), peripheral device set 114 (including user interface (UI), device set 123, storage 124, Internet of Things (IoT) sensor set 125), and network module 115. Remote server 104 includes remote database 130. Public cloud 105 includes gateway 140, cloud orchestration module 141, host physical machine set 142, virtual machine set 143, and/or container set 144.

Network 102 may be comprised of wired or wireless connections. For example, connections may be comprised of computer hardware such as copper transmission cables, optical transmission fibers, wireless transmission, routers, firewalls, switches, gateway computers and/or edge servers. Network 102 may be described as any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. Other types of networks that can be used to interconnect the various computer systems 101, end user devices 103, remote servers 104, private cloud 106 and/or public cloud 105 may include Wireless Local Area Networks (WLANs), home area network (HAN), backbone networks (BBN), peer to peer networks (P2P), campus networks, enterprise networks, the Internet, single tenant or multi-tenant cloud computing networks, the Public Switched Telephone Network (PSTN), and any other network or network topology known by a person skilled in the art to interconnect computing systems 101.

End user device 103 can include any computer device that can be used and/or controlled by an end user (for example, a customer of an enterprise that operates computing system 101) and may take any of the forms discussed above in connection with computing system 101. EUD 103 may receive helpful and useful data from the operations of computing system 101. For example, in a hypothetical case where computing system 101 is designed to provide a recommendation to an end user, this recommendation may be communicated from network module 115 of computing system 101 through WAN 102 to EUD 103. In this example, EUD 103 can display, or otherwise present, the recommendation to an end user. In some embodiments, EUD 103 may be a client device, such as thin client, thick client, mobile computing device such as a smart phone, mainframe computer, desktop computer and so on.

Remote server 104 may be any computing systems that serves at least some data and/or functionality to computing system 101. Remote server 104 may be controlled and used by the same entity that operates computing system 101. Remote server 104 represents the machine(s) that collect and store helpful and useful data for use by other computers, such as computing system 101. For example, in a hypothetical case where computing system 101 is designed and programmed to provide a recommendation based on historical data, the historical data may be provided to computing system 101 from remote database 130 of remote server 104.

Public cloud 105 may be any computing systems available for use by multiple entities that provide on-demand availability of computer system resources and/or other computer capabilities including data storage (cloud storage) and computing power, without direct active management by the user. The direct and active management of the computing resources of public cloud 105 can be performed by the computer hardware and/or software of cloud orchestration module 141. The computing resources provided by public cloud 105 can be implemented by virtual computing environments that run on various computers making up the computers of host physical machine set 142, and/or the universe of physical computers in and/or available to public cloud 105. The virtual computing environments (VCEs) may take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through network 102.

VCEs can be stored as “images.” A new active instance of the VCE can be instantiated from the image. Two types of VCEs may include virtual machines and containers. A container is a VCE that uses operating-system-level virtualization, in which the kernel allows the existence of multiple isolated user-space instances, called containers. These isolated user-space instances may behave as physical computers from the point of view of programs 150 running in them. An application 150 running on an operating system 122 can utilize all resources of that computer, such as connected devices, files and folders, network shares, CPU power, and quantifiable hardware capabilities. Applications 150 running inside a container of container set 144 may only use the contents of the container and devices assigned to the container, a feature which may be referred to as containerization.

Private cloud 106 may be similar to public cloud 105, except that the computing resources may only be available for use by a single enterprise. While private cloud 106 is depicted as being in communication with network 102 (such as the Internet), in other embodiments a private cloud 106 may be disconnected from the internet entirely and only accessible through a local/private network. A hybrid cloud may refer to a composition of multiple clouds of different types (for example, private, community or public cloud types), and the plurality of clouds may be implemented or operated by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 may be both part of a larger hybrid cloud environment.

Referring now to FIG. 3, illustrated is a block diagram of an example dynamic conversation engagement system 300, in accordance with aspects of the present disclosure.

As depicted, the dynamic conversation engagement system 300 includes a user 302, a conversation 304, an entity 306, a template generator 308, a user profile 310, a geolocation 312 with a term database 314, a question/answer database 316, and an optimal template script 318.

In some embodiments, the user 302 initiations the conversation 302 with the entity 306 (e.g., chatbot, another user, a subject matter expert, helpline operator, etc.). In some embodiments, the user 302 may have an associated user profile 310 that includes user profile settings and information. In some embodiments, the user profile 310 may be a corpus/repository of one or more user profiles (e.g., more than one user profile).

In some embodiments, when the conversation 304 is initiated, the dynamic conversation engagement system 300 utilizes the template generator 308. The templated generator 308 then: analyzes the user profile 310, communicates with the geolocation database 312, and communicates with/analyzes the question/answer database 316. In some embodiments, the template generator 308 analyzes the user profile 310 to identify user 302 specific information, such as their communication preferences, etc. In some embodiments, the template generator 308 communicates with the geolocation database 316 based on geolocation information found in the user profile 310; the template generator 308 then accesses the term database 314 as based on the geolocation information. In some embodiments, the term database 314 may include gerund, prose, syntactical, etc. information as it relates to a geolocation. In some embodiments, the template generator 308 communicates with the question/answer database 316 in real time as the conversation 304 is being had.

In some embodiments, the question/answer database 316 includes the questions and answers from both the user 302 and/or the entity 306. In some embodiments, the question/answer database 316 includes historical questions/answers from previous conversations. Regardless of embodiment, the template generator 308 utilizes the question/answer database 316 to update the optimal template script 318 in real time with questions and answers for the entity 306 to reply/communicate in the conversation 304 with the user 302. The replies/communications are in terms (as provided by the term database 314), that the user 302 has preference for.

Explained another way, in more detail, the dynamic conversation engagement system 300 generates a user training corpus, or the databases (e.g., 312, 314, and 316), by considering factors such as the following, but not limited to: a user's (e.g., user 302) product attributes (e.g., what product is the user 302 contacting the entity 306); the user's geolocation and known terminologies related to the local conventions; the linguistic attributes of the conversation. For example, how and when to ask a question in certain circumstances (e.g., what types of questions are considered formal vs. informal); the user's local relevant business etiquette; the user's upcoming new product and features from the existing products (which can be found in the user profile 310); new vocabularies generated from the trending hashtags and the social networking platform in this product domain (e.g., to be put in the term database 314); and the channel of the communication (e.g. phone, chat, SMS, video conference, in-person, etc.).

In some embodiments, the dynamic conversation engagement system 300 uses one or more machine learning technique to collect the user profile 310 data, location, and/or language-related data. In some embodiments, utilizing the databases (e.g., 312, 314, and 316) and the user profile 310 data as input, the dynamic conversation engagement system 300 generates an idealized template script (e.g., the optimal template script 318) for the conversation 304, which could then be extended out to the entity 306 or the user 302. In this embodiment, this could be a high-level summary of items to cover and not a detailed “read me” type of script.

In some embodiments, the dynamic conversation engagement system 300 utilizes script updates based on Delta processing, which may occur based on a dynamic progression of the conversation 304. As the conversation 304 iterates into the certain following steps within the process, the updates are compared with the delta.

In some embodiments, at the time a live conversation (e.g., the conversation 304) occurs (or on review of a recorded conversation) the dynamic conversation engagement system 300 assigns different color codes to each of the speakers during the conversation 304. The dynamic conversation engagement system 300 further assigns additional color codes and annotations to different types of question and answers from the conversation 304.

In some embodiments, the dynamic conversation engagement system 300 continuously collects metadata such as color codes and annotations from the conversation 304, and said information could be housed/stored in one or more of the databases (e.g., 312, 314, and 316).

In some embodiments, the dynamic conversation engagement system 300 analyzes the metadata information from the conversation 304 to determine these criteria, but not limited to: whether one of the speakers is the main speaker in the conversation; hat type of opening statement was used; what type of questions were/have been asked; how many times the same questions were repeated; was there an appropriate remark at the end of the conversation (e.g., was your question answered?, etc.); and were there any follow up action items?, etc. In some embodiments, part of this analysis may be a comparative analysis between the optimal template script 318 and the conversation 304.

In some embodiments, the dynamic conversation engagement system 300 assigns different weights to different criteria based on the intended outcome of the conversation 304. The dynamic conversation engagement system 300 monitors the outcome from the overall conversation, and as additional conversations are initiated, they are taken in context of previous conversations with the same participants/users (e.g., the user 302) as well as the optimal template script 318.

In some embodiments, the dynamic conversation engagement system 300 compares the analyzed metadata information with the outcome to determine what has caused a positive outcome versus a negative outcome, thus subsequent conversations will have optimal template scripts geared toward more positive outcomes.

In some embodiments, the dynamic conversation engagement system 300 is developed through machine learning-based techniques. The dynamic conversation engagement system 300 can further train, or provide guidance to, the entity 306 on using an appropriate opening statement, questions, closing statement, follow up action items on existing and new products so the entity 306 can communicate with the user 302 most efficiently.

In some embodiments, the dynamic conversation engagement system 300 can be periodically updated and retrained based on dynamically changing user information and feedback. In some embodiments, the dynamic conversation engagement system 300 monitors the trending information that is shared through social media and other publicly available channels. The dynamic conversation engagement system 300 then identifies new trending information and the urgency to update its training models.

As a brief example, assume Susan is a management consultant that needs to work with physicians to understand their needs in terms of how they can improve the patient treatment experience. Susan usually works with her clients through conference calls. Susan works with different types of companies from varying industries. She needs to quickly learn the products and adapt to the new technologies used in the products. Susan needs to sell the product to a global company's team in France. Susan utilizes the dynamic conversation engagement system 300 to quickly receive feedback on her performance, such as communication techniques and understanding of the client's cultures and products. The dynamic conversation engagement system 300 updates the information related to different products and companies Susan needs to work with and provides her with visual feedback (e.g., the optimal template script 318), so she understands the areas to focus and improve on.

As another example, assume Jessica is a subject matter expert for closing commerce-based sales deals within various cloud services within her business area, and she is from Toronto, Canada. Jessica is brought in to aid within the closing process for Latin America. She teams up with Jose, as Jose is a top seller within the Latin America marketplace as well based out of Brasilia, Brazil. Together, they team up to form a dynamic sales duo and agree to make dynamic shifts and changes while using the tooling, as they are both considered “top sellers” within their respective areas. The dynamic conversation engagement system 300 updates within the background based on their unique positions of leadership within the software cloud services area. Further, the dynamic conversation engagement system 300 will color code the input for Jose into green and the data/metadata for Jessica with a red highlighting text. Next, they are working together on helping a new high value, complex customer engage with the cloud services product. The dynamic conversation engagement system 300 is engaged and the corpus is learning pertaining to how, why, and when the customer is engaged. They are teaching/updating the corpus as they go based on Jose's mastery of the Brazilian business etiquette. Further, Jessica achieves a great working understanding of the situation while being paired with Jose.

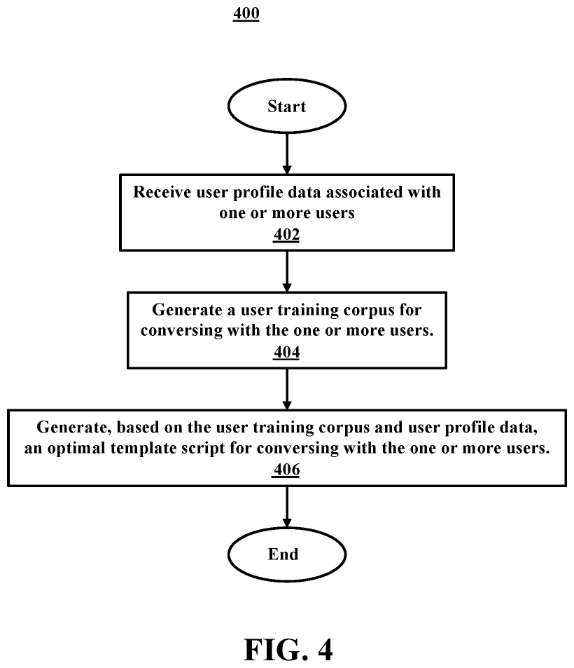

Referring now to FIG. 4, illustrated is a flowchart of an example method 400 for a dynamic conversation engagement, in accordance with aspects of the present disclosure. In some embodiments, the method 400 may be performed by a processor, such as a processor of the dynamic conversation engagement system 300.

In some embodiments, the method 400 begins at operation 402, where a processor receives user profile data associated with one or more users. In some embodiments, the method 400 proceeds to operation 404, where the processor generates a user training corpus for conversing with the one or more users. In some embodiments, the method 400 proceeds to operation 406, where the processor generates, based on the user training corpus and user profile data, an optimal template script for conversing with the one or more users. In some embodiments, after operation 406, the method may end.

In some embodiments, discussed below, there are one or more operations of the method 400 not depicted for the sake of brevity and which are discussed throughout this disclosure. Accordingly, in some embodiments, the processor may update dynamically, the optimal template script as a conversation progresses between one of the one or more users and an entity.

In some embodiments, the updating may include: delta processing, where the delta processing results from comparison of a state of the conversation with one or more particular conversation milestones, and receiving real-time feedback from a conversation specialist, which may be the entity (e.g., chatbot, other user, etc.).

In some embodiments, the user training corpus (e.g., databases 312, 314, and 316) may include: one or more product attributes, a geolocation and known terminologies related to the geolocation, linguistic attributes of a language of the geolocation, new vocabularies generated from social networking platforms utilized in the geolocation, and preferred communication channels for different types of communication interactions.

In some embodiments, the processor may assign different color codes to respective communications of each user during the conversation. The processor may further assign different annotations to different types of question/answer pairs during the conversation, where the question/answer pairs are derived from the respective communications.

In some embodiments, the processor may analyze metadata associated with the different color codes assigned to the respective communications of each user, and the different annotations assigned to the different types of question/answer pairs during the conversation to determine conversational data, where the analyzing may include the processor determining, whether a particular user is leading the conversation, types of opening statements used in the conversation, types of questions asked during the conversation, a number of times similar questions are repeated during the conversation, and any required follow up actions.

In some embodiments, the processor may compare conversational data associated with the conversation to an outcome of the conversation to determine correlations between the conversational data and one or more positive/negative outcomes of the conversation, and update the optimal template script for conversing with the one of the one or more users based on the comparison.

It is noted that the descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer system for dynamic conversation engagement, the computer system comprising:
one or more processors, one or more computer-readable memories and one or more computer-readable storage media;
program instructions, stored on at least one of the one or more storage media for execution by at least one of the one or more processors via at least one of the one or more memories, to receive user profile data associated with one or more users;
program instructions, stored on at least one of the one or more storage media for execution by at least one of the one or more processors via at least one of the one or more memories, to generate a user training corpus for conversing with the one or more users; and
program instructions, stored on at least one of the one or more storage media for execution by at least one of the one or more processors via at least one of the one or more memories, to generate based on the user training corpus and user profile data, an optimal template script for conversing with the one or more users.

2. The computer system of claim 1, further comprising:
program instructions, stored on at least one of the one or more storage media for execution by at least one of the one or more processors via at least one of the one or more memories, to update, dynamically, the optimal template script as a conversation progresses between one of the one or more users and an entity.

3. The computer system of claim 2, wherein the updating comprises:
delta processing, wherein the delta processing results from comparison of a state of the conversation with one or more particular conversation milestones, and
receiving real-time feedback from a conversation specialist.

4. The computer system of claim 1, wherein the user training corpus includes:
one or more product attributes, a geolocation and known terminologies related to the geolocation, linguistic attributes of a language of the geolocation, new vocabularies generated from social networking platforms utilized in the geolocation, and preferred communication channels for different types of communication interactions.

5. The computer system of claim 1, further comprising:
program instructions, stored on at least one of the one or more storage media for execution by at least one of the one or more processors via at least one of the one or more memories, to assign different color codes to respective communications of each user during the conversation; and
program instructions, stored on at least one of the one or more storage media for execution by at least one of the one or more processors via at least one of the one or more memories, to assign different annotations to different types of question/answer pairs during the conversation, wherein the question/answer pairs are derived from the respective communications.

6. The computer system of claim 5, further comprising:
program instructions, stored on at least one of the one or more storage media for execution by at least one of the one or more processors via at least one of the one or more memories, to analyze metadata associated with the different color codes assigned to the respective communications of each user, and the different annotations assigned to the different types of question/answer pairs during the conversation to determine conversational data, wherein the analyzing includes:
determining, whether a particular user is leading the conversation, types of opening statements used in the conversation, types of questions asked during the conversation, a number of times similar questions are repeated during the conversation, and any required follow up actions.

7. The computer system of claim 6, further comprising:
program instructions, stored on at least one of the one or more storage media for execution by at least one of the one or more processors via at least one of the one or more memories, to compare conversational data associated with the conversation to an outcome of the conversation to determine correlations between the conversational data and one or more positive/negative outcomes of the conversation; and
program instructions, stored on at least one of the one or more storage media for execution by at least one of the one or more processors via at least one of the one or more memories, to update the optimal template script for conversing with the one of the one or more users based on the comparison.

8. A computer-implemented method for dynamic conversation engagement, the method comprising:
receiving, by a processor, user profile data associated with one or more users;
generating a user training corpus for conversing with the one or more users; and
generating, based on the user training corpus and user profile data, an optimal template script for conversing with the one or more users.

9. The method of claim 8, further comprising:
updating, dynamically, the optimal template script as a conversation progresses between one of the one or more users and an entity.

10. The method of claim 9, wherein the updating comprises:
delta processing, wherein the delta processing results from comparison of a state of the conversation with one or more particular conversation milestones, and
receiving real-time feedback from a conversation specialist.

11. The method of claim 8, wherein the user training corpus includes:
one or more product attributes, a geolocation and known terminologies related to the geolocation, linguistic attributes of a language of the geolocation, new vocabularies generated from social networking platforms utilized in the geolocation, and preferred communication channels for different types of communication interactions.

12. The method of claim 8, further comprising:
assigning different color codes to respective communications of each user during the conversation; and
assigning different annotations to different types of question/answer pairs during the conversation, wherein the question/answer pairs are derived from the respective communications.

13. The method of claim 12, further comprising:
analyzing metadata associated with the different color codes assigned to the respective communications of each user, and the different annotations assigned to the different types of question/answer pairs during the conversation to determine conversational data, wherein the analyzing includes:
determining, whether a particular user is leading the conversation, types of opening statements used in the conversation, types of questions asked during the conversation, a number of times similar questions are repeated during the conversation, and any required follow up actions.

14. The method of claim 13, further comprising:
comparing conversational data associated with the conversation to an outcome of the conversation to determine correlations between the conversational data and one or more positive/negative outcomes of the conversation; and
updating the optimal template script for conversing with the one of the one or more users based on the comparison.

15. A computer program product for a dynamic conversation engagement, the computer system comprising:
one or more computer-readable storage media;
program instructions, stored on at least one of the one or more storage media, to receive user profile data associated with one or more users;
program instructions, stored on at least one of the one or more storage media, to generate a user training corpus for conversing with the one or more users; and
program instructions, stored on at least one of the one or more storage media, to generate based on the user training corpus and user profile data, an optimal template script for conversing with the one or more users.

16. The computer program product of claim 15, further comprising program instructions, stored on at least one of the one or more storage media, to update, dynamically, the optimal template script as a conversation progresses between one of the one or more users and an entity.

17. The computer program product of claim 16, wherein the updating comprises:
delta processing, wherein the delta processing results from comparison of a state of the conversation with one or more particular conversation milestones, and
receiving real-time feedback from a conversation specialist.

18. The computer program product of claim 15, wherein the user training corpus includes:
one or more product attributes, a geolocation and known terminologies related to the geolocation, linguistic attributes of a language of the geolocation, new vocabularies generated from social networking platforms utilized in the geolocation, and preferred communication channels for different types of communication interactions.

19. The computer program product of claim 15, further comprising program instructions, stored on at least one of the one or more storage media, to:
assign different color codes to respective communications of each user during the conversation; and
assign different annotations to different types of question/answer pairs during the conversation, wherein the question/answer pairs are derived from the respective communications.

20. The computer program product of claim 19, further comprising program instructions, stored on at least one of the one or more storage media, to analyze metadata associated with the different color codes assigned to the respective communications of each user, and the different annotations assigned to the different types of question/answer pairs during the conversation to determine conversational data, wherein the analyzing includes:
determining, whether a particular user is leading the conversation, types of opening statements used in the conversation, types of questions asked during the conversation, a number of times similar questions are repeated during the conversation, and any required follow up actions.
